(19) United States
(12) Patent Application Publication
(10) Pub. No.: US 2023/0306548 A1
(43) Pub. Date: Sep. 28, 2023

(54) EWALLET PLATFORM TO FACILITATE FLEXIBILITY IN USER TRANSACTIONS

(71) Applicant: Craig Potts, Scottsdale, AZ (US)

(72) Inventor: Craig Potts, Scottsdale, AZ (US)

(21) Appl. No.: 18/190,944

(22) Filed: Mar. 27, 2023

Related U.S. Application Data
(60) Provisional application No. 63/269,935, filed on Mar. 25, 2022.

(51) Int. Cl. G06Q 50/34; G06Q 20/36; G06Q 20/10; G06Q 20/40; G07F 17/32

(52) U.S. Cl. CPC G06Q 50/34; G06Q 20/36; G06Q 20/1085; G06Q 20/40155; G07F 17/3244; G07F 17/3234; G06Q 20/3276

(57) ABSTRACT

A device may include an eWallet platform processor configured to accommodate user eWallet transactions with in a gaming institution, comprising, withdrawals, transfers, and deposits, the eWallet platform further configured to process ACH transactions, credit card clearing operations, and credit applications processes, the eWallet platform processor further comprising a user wireless communication interface configured to communicate with an eWallet app installed on a user mobile device. A slot management system having a slot management interface configured to securely interface with the eWallet platform processor is also used, the slot management system configured to communicate with systems housed within the gaming institution including an ATM, slot machines, and cashier systems The slot management system further having a gaming institution wireless interface configured to interact with the eWallet app which will enable eWallet transactions involving the ATM, the slot machines and the cashier system, wherein eWallet require a GPS confirmation signal from the user mobile device confirming that the user is located within the gaming institution, and where each eWallet transaction system will require a user confirmation signal received from the eWallet app operating on the user mobile device.

### BACKGROUND

Gaming institutions are universally interested in providing convenience for customers, including easy access to financial resources when necessary. Well known sources for funding include ticket windows and cashiers that are placed throughout the gaming institution, ATM's provided at appropriate locations, and institutional financing through the gaming institution itself. One example of this institutional financing will include house accounts, where customers have preexisting arrangements with the gaming institution. In an effort to provide convenience, many gaming machines and cashiers can operate using tickets or vouchers alone, as opposed to requiring cash at all times which can be financed in many ways. Intermittent

Although financial institutions and gaming institutions have coordinated many resources and practices to provide many conveniences and enhancements for their customers, certain improvements and additional capabilities would be beneficial. More specifically, additional mechanisms to access cash or funds would provide further convenience for users.

Financial institutions are a central part of today's society and play a critical role in the management of finances, both personal and commercial. In many cases, registered financial institutions are federally insured (i.e. FDIC insured, or insured by other government agencies) thus providing stability/security for the world's financial resources and providing confidence for customers.

In a similar manner, financial institutions are highly regulated, and must follow specific rules well established practices. That said, these institutions have become very convenient and provide customers with several tools and resources. Many of these tools/resources allow customers to easily access funds and accounts, thus providing easy mechanisms to coordinate desired transfers and/or payments. As is also well known virtual banks have become mainstream, wherein customers access resources and funds exclusively via online interfaces. Using these mechanisms, funds can be withdrawn from traditional accounts utilizing appropriate tools, accessed via on-line resources, mobile devices, kiosks, etc. That said, multiple security measures are used and specific protocols are followed to insure security of accounts. Other mechanisms used to access accounts include the well-known ATM, which allows users to easily access funds and preform multiple financial transactions. More recently, a tap and pay, or transactions enabled by mobile devices have also emerged as mainstream mechanisms to carry out financial transactions. Examples of these online mechanisms include Android Pay and Apple Pay. Also, the concept of an electronic wallet (eWallet) is somewhat common in present day society but can take many forms and mean many different things to users.

While access to funds has become more convenient, tension still exists when financial resources are provided within casinos and gaming institutions. Naturally, the gaming institutions are interested in providing convenience for their customer, including access to financial resources and accounts. Alternatively, various levels of responsible gaming practices must be observed, thus helping insure that those having gambling problems can be identified and helped where necessary. Although this tension is well recognized, mechanisms and processes can be instituted which help to balance many of these concerns.

Naturally, most gaming machines or gaming devices now provide the ability to receive cash directly at the machine. These machines make use of long established mechanisms for handling coins and/or currency. That said, mechanisms to dispense cash are less common. The expense and undertaking of equipment every gaming machine with mechanisms to both receive and dispense cash is somewhat undesirable. This is one reason paper tickets or printed tickets are commonly used in current day gaming machines. As is well known, these printed tickets can be provided at each machine, and then inserted into other machines, or “cashed out” when the player is no longer interested in continued play.

Based on the foregoing issues and concerns, it is desirable to provide a mechanism which could more easily provide resources to casino users. This could include access to funds, and other financial resources.

### SUMMARY

A system and related processes are specifically configured to provide an eWallet to users that is uniquely configured for use in many different situations, including electronic commerce and a gaming institution. Although many various can exist, the eWallet account is accessed primarily through App on phone/mobile device. The eWallet account is capable of coordinating with many different devices or systems such as ATM's, POS devices, etc. The operating environment supporting the user's eWallet accounts adapt to setting (e.g. when in Casino will recognize and coordinate with gaming machines, etc.). The eWallet can be affiliated with several other accounts, but maintained separately by an account processor which is uniquely positioned to provide many features, advantages and capabilities.

The system further allows for the creation of multiple account types, including a “token” account, gift card account, Crypto account, etc. The system can further allow access to other resources, such as the ability to new credit accounts. The system and the processor that is managing the system, coordinate all security and back-end processing systems, and thus have insight into further levels of information. In one embodiment, only Ecommerce or Internet based transactions involved, thus providing additional advantages.

In some aspects, the techniques described herein relate to an eWallet transaction platform for coordinating the management and use of a user's eWallet account within a gaming institution. The eWallet transaction platform may include an eWallet platform processor configured to provide financial transaction support to accommodate user eWallet transactions, including, withdrawals, transfers, and deposits, the eWallet platform further configured to process ACH transactions, credit card clearing operations, and credit applications processes, the eWallet platform processor further including a user wireless communication interface configured to communicate with an eWallet app installed on a user mobile device. The eWallet transaction platform may also include a slot management system having a slot management interface configured to securely interface with the eWallet platform processor, the slot management system further configured to communicate with casino systems including an ATM, a plurality of slot machines, and a cashier system, the slot management system further having a gaming institution wireless interface configured to interact with the eWallet app which will enable eWallet transactions involving the ATM, the plurality of slot machines and the cashier system. The eWallet transactions involving the ATM, any one of the plurality of slot machines or the cashier system require a GPS confirmation signal from the user mobile device confirming that the user is located within the gaming institution, and where each eWallet transaction will require a user confirmation signal received from the eWallet app operating on the user mobile device, wherein the GPS confirmation signal and the user confirmation signal are both received via the gaming institution wireless interface.

In some aspects, the techniques described herein relate to an eWallet transaction platform wherein the slot management system will recognize the presence of the user mobile device withing the gaming institution and will automatically provide signals to the user mobile device to cause operation of the eWallet app to be altered, to thereby better accommodate coordination with the ATM, gaming machine or cashier system.

In some aspects, the techniques described herein relate to an eWallet transaction platform wherein the user confirmation signal will be generated by the user mobile device scanning a barcode or QR code.

In some aspects, the techniques described herein relate to an eWallet transaction platform wherein the eWallet platform processor is further configured to receive data from the eWallet app installed on the user mobile device to allow for enrollment in the eWallet, account including electronically receiving information necessary to access an existing account at a user's financial institution.

In some aspects, the techniques described herein relate to an eWallet transaction platform wherein the eWallet platform processor is further configured to provide a user portal which supports a user interface allowing the user to access status information regarding the eWallet account and to initiate any one of the user eWallet transactions, and a merchant portal configured provide a merchant with information regarding a plurality of eWallet account managed by the merchant.

In some aspects, the techniques described herein relate to an eWallet transaction platform wherein the slot management system is configured to provide a gaming institution portal which allows the gaming institution to view eWallet transactions occurring withing the gaming institution.

### BRIEF DESCRIPTION OF THE DRAWINGS

Further details and advantages of the described systems and methods can be seen from the description below, in conjunction with the drawings in which:

FIG. 1 is a schematic block diagram of the various subsystems and parties involved in the present eWallet system;

FIG. 2 is an additional block diagram of the eWallet system;

FIG. 3 is a block diagram illustrating a gaming facility application;

FIG. 4 presents a dashboard view of the payment system coordination of the eWallet platform;

FIG. 5 shows a terminal dashboard;

FIG. 6 presents and exemplary user menu dashboard

FIG. 7 presents a user statement view;

FIGS. 8A-8B present one example of how money is moved using simple QR code scans;

FIGS. 9A-9D illustrate various user screens for the on-line management of accounts; and

FIGS. 10A-10D show various eWallet management user screens.

### DESCRIPTION

To provide several finance related capabilities and the coordinated operation of various financial processes, an eWallet account platform 10 provides components and systems to allow the coordinated operation and communication of multiple subsystems, each tailored to carry out specific functions or to operate in specific settings. The operation of these subsystems is coordinated by a platform processor/controller, which includes various communication capabilities, instructions, and processing capabilities to coordinate the overall operation of the eWallet system. As used herein, the term “processor/controller” is utilized to denote an overall eWallet system coordinator and is intended to be defined more broadly than the well-known computer processor or controller. As will be further discussed below, the eWallet processing platform will include capabilities to communicate with financial transaction processing systems, financial account access systems, point of sale systems, ATM and ACH processing systems, gaming terminals, gaming system controllers, and other terminals/kiosks. Several of these components are specifically designed to meet particular needs and provide particular capabilities.

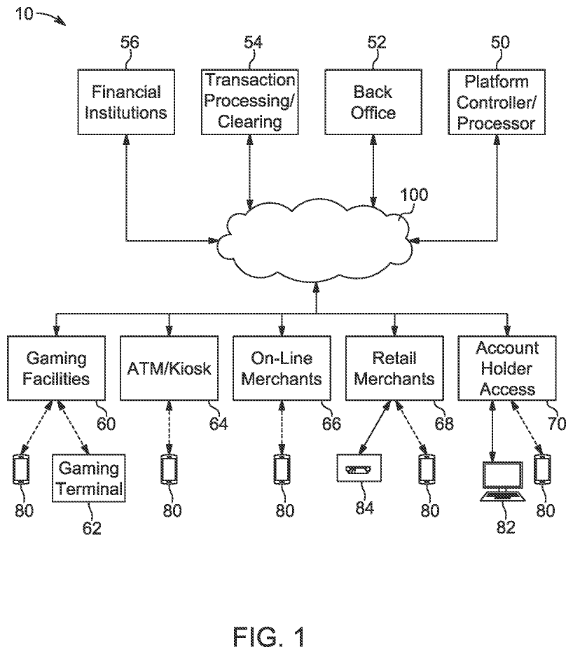

Referring now to FIG. 1, a high-level schematic block diagram of eWallet account platform 10 is illustrated. In this embodiment, processing platform generally includes a platform controller/processor 50 which is responsible for overall coordination of multiple systems, and which provide several beneficial features for all parties involved. As shown, platform controller/processor 50 is in communication with a cloud based communication system 100 (i.e. the internet) to accommodate necessary communication. It is noted that certain communication functions are carried out using prescribed protocols that provide several levels of security. In addition, processing platform 10 includes back office systems 52 which are also in communication with the cloud based communication system 100. As will be further discussed below, communication with transaction processing/clearing systems 54 and financial institutions 56 will be necessary to carry out the various functions contemplated. Again, communication with these systems is achieved via the cloud based communication system 100.

Also communicating with the cloud based communication system 100 are multiple “user” systems to allow individual account holders and merchants to take advantage of the features provided by eWallet account platform 10. In the embodiment generally illustrated in FIG. 1 these user systems include a gaming facility 60, ATM/Kiosk devices 64, on-line merchants 66, retail merchants 68, and account holder access systems 70. These systems are configured to operate as expected, but also allow for the coordinated operation with platform controller/processor 50 to provide additional features and capabilities. As will be discussed further below, these user systems are accessible using many different interfaces components. Illustrated in FIG. 1 is a user mobile phone 80 which is used to interact in various ways and provide convenient and secure access to accounts or other systems. Other interface devices could include other computing devices 82 (including personal computers, laptops, tablets, notebooks, etc.). Additional, POS devices 84 might be used in certain situations, particularly those involving retail merchants 68.

As one feature of eWallet account platform 10, necessary communication and instructions are shared to multiple devices to allow users to manage user eWallet accounts from several different aspects and perspectives. This includes the ability to create eWallet accounts, transfer or move funds as desired, manage account details, and coordinate transactions. In addition, users will have the ability to interact with ATMs or point of sale devices, to carry out desired transactions. Further, eWallet account platform 10 will coordinate with applications running on a user's cell phone/mobile device 80 to carry out several types of transactions including cash advances, credit account applications, access to funds in several formats, access to crypto currency, access to internal tokens or credits, or other related accounts. Based upon the communication capabilities, security protocols, and processing techniques carried out by eWallet platform controller/processor 50, there are also several back-end features which provide additional value and data to other third parties such as merchants, financial institutions, etc.

While variations exist, eWallet account platform 10 generally works with eWallet Accounts. As will be recognized these eWallet accounts are accessed primarily through an App on phone/mobile device and are set up to coordinate with a wide variety of other devices or systems, such as ATM's, POS devices, etc. The eWallet account is also configure to adapt to the environment, such as recognizing the location of the user and providing necessary reconfiguration (e.g. recognizing when in the gaming establishment and more efficiently coordinating with gaming machines, casino systems, etc.). The eWallet account may be linked to other accounts, but maintained separately by eWallet account platform 10. Since the eWallet account can be set up to support multiple account types, including a “token” account, gift card, Crypto, pre-paid, etc. The eWallet account can also accommodate access to other resources, such as new credit accounts, etc. By coordinating with the eWallet account platform, all parties involved can also trade and transact in crypto currency, or tokens.

As will be discussed in further detail below, security and back-end processing systems are coordinated by eWallet account platform 10 to thus provide desirable levels of separation. In some cases, only ecommerce of internet based transactions are involved, but variations may exist. In this embodiment, eWallet platform controller/processor 50 is specifically configured in certain embodiments to a process only ecommerce or internet based transactions, thus streamlining its capabilities and providing further benefits to users.

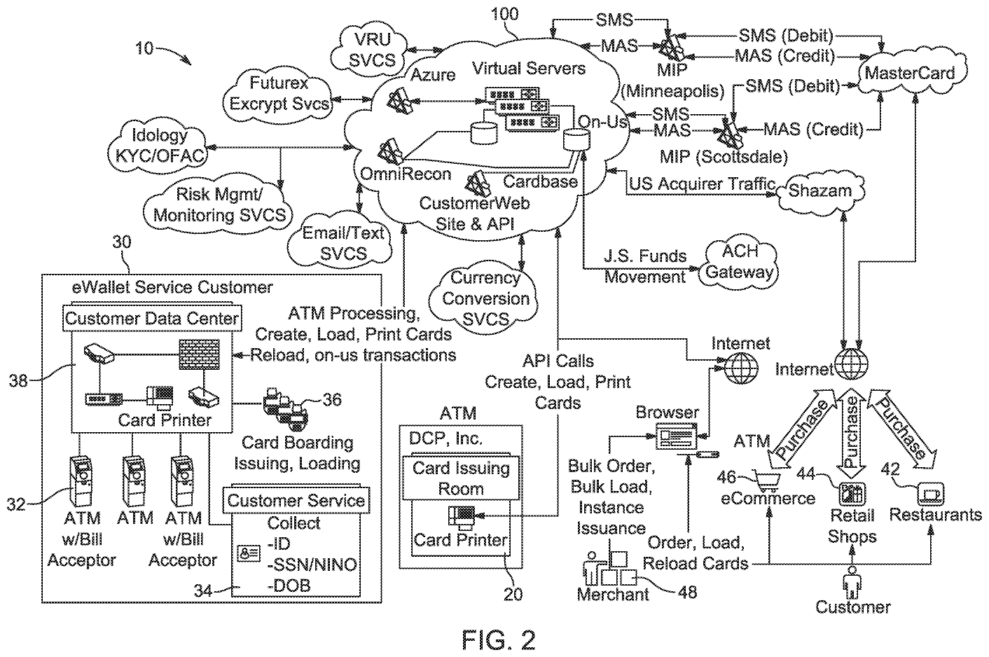

Referring now to FIG. 2, eWallet account platform 10 is again shown in an alternative embodiment. Again, much of the communication shown in FIG. 2 is accomplished using cloud based communication system 100 and other related systems. Cloud based communication system 100 is again configured to carry out necessary functions and features, and to help coordinate communication between the multiple subsystems as needed. In this embodiment, a plurality of user interface features 30 are also provided, including ATMs 32, card processing systems 34, POS systems 36 and card issuing systems 20. A customer data center 38 is also provided, which includes the capability to print a credit and/or debit and/or gift cards, while also providing necessary security protocols for all user/customer data.

In addition to the systems mentioned above, the eWallet account platform 10 includes connections and capabilities allowing a customer to interact with restaurants 42, retail shops 44, e-commerce vendors 46, and other merchants 48. All of these various providers and/or service offerings are also connected directly or indirectly to a cloud based communication system 100, which can be easily configured to have significant processing power and capability. Among the various capabilities provided or facilitated by cloud based communication system 100 are the ability to carry out currency conversions, the ability to provide fraud protection and security capabilities, the ability to process credit cards through the well-known card processing systems, to provide ACH transaction capabilities, etc. Other features and advantages will be seen as better described below.

As mentioned above, the eWallet account platform 10 can include a card issuing system 20, which allows for the on-line processing of credit card applications. It is anticipated that card issuing system 20 is capable of processing instant issue applications and issuing credit to applicants in very short periods of time. In this context, credit could be issued in the form of prepaid debit cards, gift cards, store credits, designated credit limits and the well-recognized credit cards. Card issuing system 20 is further capable of issuing and printing new cards at designated locations, or loading existing financial cards under control of the user.

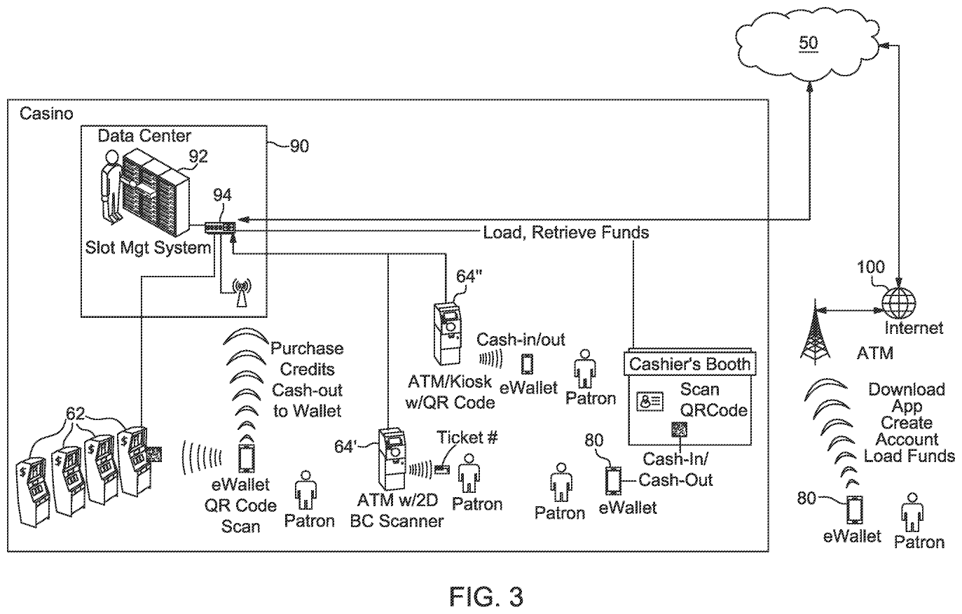

As mentioned above, one specific location where the eWallet account platform 10 is particularly useful is within a casino or gaming establishment 60. An example of this application is illustrated in FIG. 3. As shown, this embodiment includes a data center 90 which coordinates multiple operations within casino 60. Within data center 90, a slot management system 92 is configured to carry our several management function, which communicates with multiple gaming terminals 62 and other systems via a communication switch 94. Although this is referred to herein as slot management system 92, it will be understood that this system is also configured to manage, control or interface with other gaming devices or operations within gaming establishment 60 to provide financial resources and eWallet access capabilities. For example, slot management system 92 will coordinate operation of any ATM's 64′, kiosks 64″, or POS devices 64′″ located within gaming establishment 60. In the embodiment illustrated in FIG. 3, it is contemplated that a cashier's booth will include a POS device 64′″ which is configured to accommodate eWallet transactions. As illustrated, slot management system 92 will communicate with gaming terminals 62 situated within casino 60. To achieve these functions, a specific slot management interface is created within slot management system 92, which provides a secure and targeted communication mechanism uniquely configured to accommodate the necessary exchange of information between the casino and eWallet patform processor 50.

Wireless communication equipment 96 is also operationally coupled to a switch 94 to allow significant security and convenience capabilities. As will be discussed below, a user's mobile device 80 is used in many circumstances as an interface or additional tool to allow access to convenience features provided by eWallet platform 10. Switch 94 is also in communication with platform controller/processor 50 to provide additional communication capabilities to other systems. Again, platform controller/processor 50 is connected to cloud-based communication system 100 (i.e. the internet), shown here to illustrate the multiple communication options available.

As further shown in the casino environment illustrated in FIG. 3, switch 94 is also in communication a cashier booth 110, which allows for personal interaction with cashiers who can assist with funding of user accounts or the issuance of gaming tickets (including use of the user's eWallet). It is contemplated that security of systems and accounts is further enhanced by including interaction with a user's mobile device 80 to accommodate or enhance transactions carried out at cashier's booth 110. As one example, a QR code could be used at cashier booth 110 to confirm the user's location, and to allow automated cash-in/cash-out functions.

Also shown in FIG. 3 are a first ATM 64′ and a second ATM 64″, which allow users (or patrons) to access accounts and fund. First ATM 64′ is configured with ticket-in/ticket-out capabilities which is well suited to meet the needs of users within casino 60. Second ATM 64″ is configured to cooperate with user mobile device 80 to further accommodate eWallet functions. This again includes the use of QR codes to allow apps running on user mobile device 80 to accommodate cash transactions, and ecommerce money transfers. It is also contemplated that either ATM 64″ or gaming machines 62 are configured to allow a user to access credit application tools (such as the card issuing features 20 discussed above).

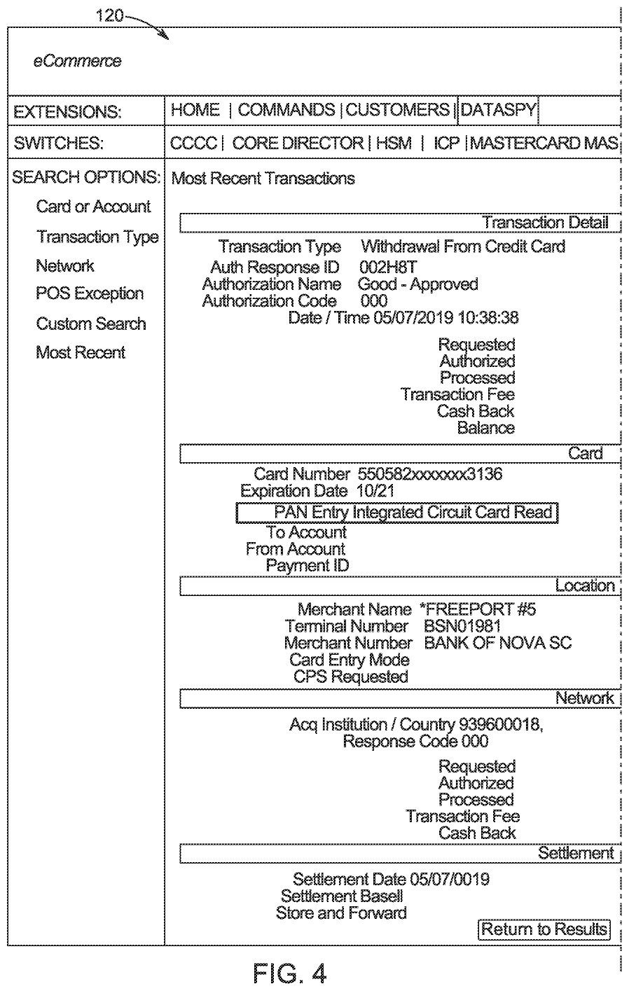

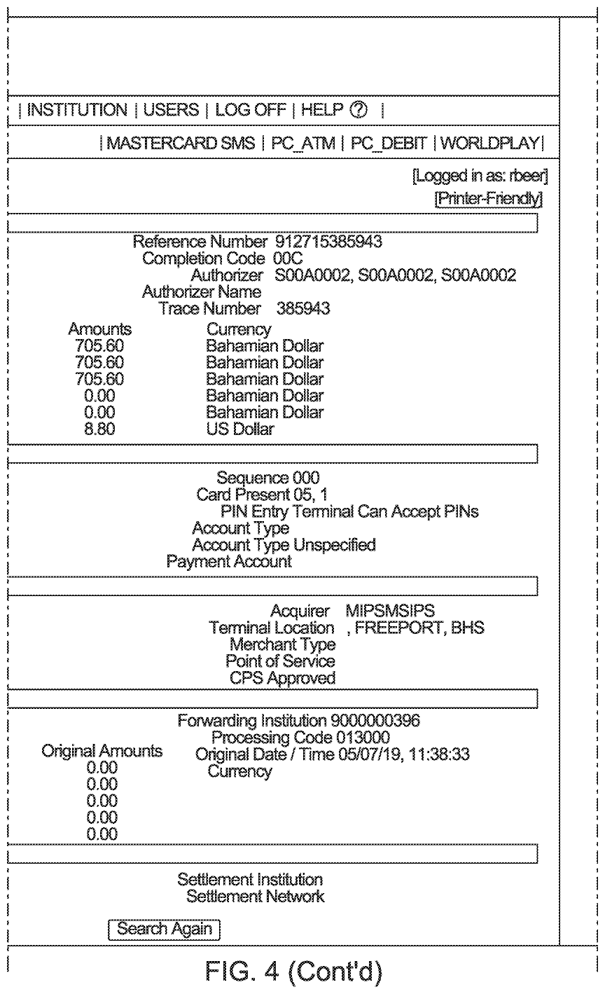

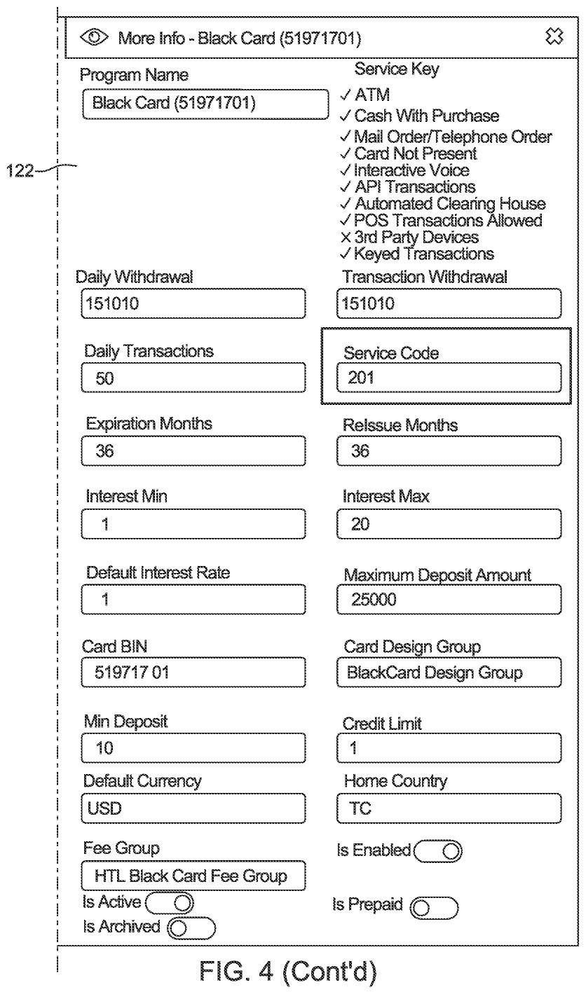

Again, eWallet account platform 10 includes certain processing tools, including transaction processing/clearing systems. This includes tools which provide support for ATM gateways and certain network gateways, such as Visa, MasterCard, Shazam and 4Cs (sometimes referred to as EMV). The coordination of these features is achieved via a support dashboard 120, such as the exemplary dashboard illustrated in FIG. 4. This also includes the ability to track card issuance activities. As illustrated, support dashboard 120 provides the ability for eWallet account platform managers to track the activity and transactions that are facilitated by various systems. As an example, transactions for a particular card can be presented in an activity window 122. This allows platform controller/processor 50 to verify that activities are being processed appropriately, and to potentially identify errors and issues that might arise. This support dashboard 120 provides eWallet platform manager to search in multiple ways, thus providing the ability to track, audit, and/or troubleshoot transactions. As can be seen, this allows for searching by particular extensions, switches, transaction types, etc. Based upon the search results, the eWallet platform manager can see multiple details of the types of transactions carried out by a eWallet account user.

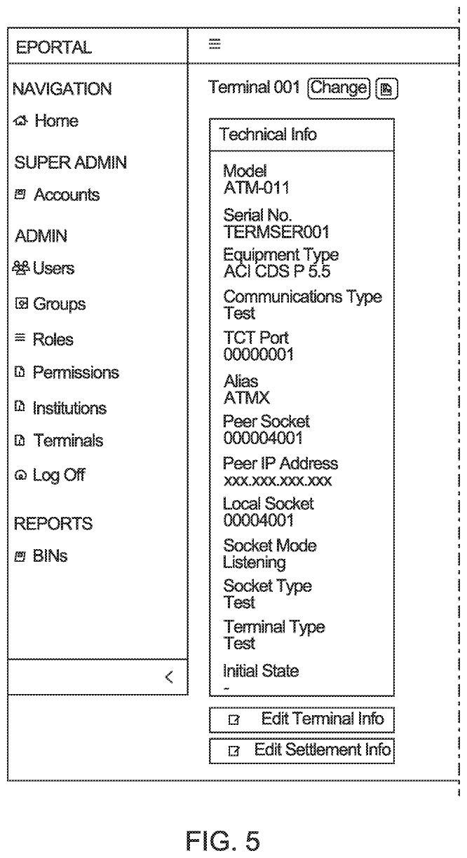

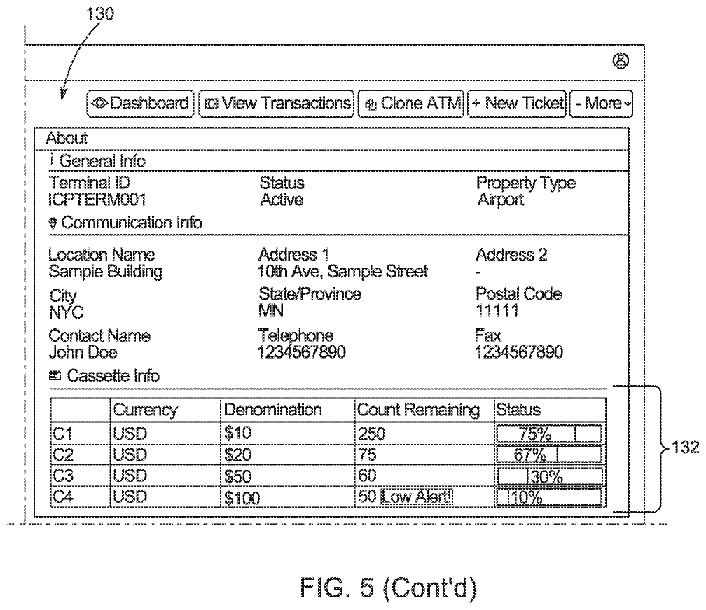

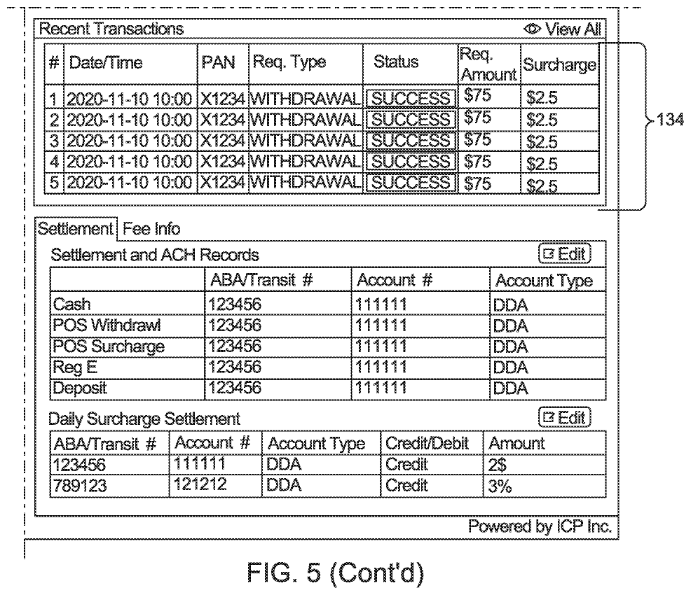

In addition to several other features discussed above, platform 10, and specifically back office systems 52 include the ability to monitor certain terminals and devices that make up portions of processing platform 10. FIG. 5 illustrates one example of this capability. In this particular example, an ATM terminal is being monitored for various activities, thus allowing platform 10 to confirm expected operation is ongoing. Further, certain details of the terminal itself can be monitored to ensure continued operation goes smoothly. As mentioned in this example, the monitor terminal is an ATM. Consequently, one feature of the monitored ATM is the cash cassette volume. More specifically, dashboard 130 includes the presentation of information related to the cash cassettes contained within the ATM. As such, the platform can confirm whether appropriate currency is stored within this particular ATM, and alert individuals to servicing needs. Additionally, dashboard 130 will display a transaction history 134, thus providing insight into the status of scheduled or settled transactions, and any additional coordination that may be needed. Although not shown in dashboard 130, this does include the ability to look up and search specific transaction details, and generate any reports or downloads requested or desired by platform managers, and/or related financial institutions. This includes the ability to search using various criteria including dates, institution identification, specific user card numbers, terminal IDs, etc. Further, information can be exported in many different formats, including Excel spreadsheets, .PDF documents or, separated values type files.

In addition to transaction searching and reporting, along with terminal monitoring, eWallet account platform 10 includes a transaction processing/clearing system, which is in communication with various financial networks and clearinghouses. Stated differently, this system allows for the processing of online payment transactions, including ecommerce, retail and prepaid type transactions, among others. Several of these transactions could be carried out via card terminals, specialized kiosks, and/or online access via traditional mechanisms (i.e. computer systems, laptops, mobile devices, etc.). Significantly, this does include the processing of eWallet transactions, which again can be initiated in multiple ways.

In addition to the features discussed above, back-end systems of eWallet account platform 10 provides interfaces and communication mechanisms to coordinate enrollment and operation of the user app, thereby allowing users to carry out features. In addition, it will provide a proprietary interface to multiple devices, including gaming machines, banks, ATM's etc. This will provide inherent security within eWallet account platform 10 when dealing with card issuers, etc. Further, the coordinated settlement processes involved between eWallet account platform 10 and casino systems, outside user accounts and banking organizations.

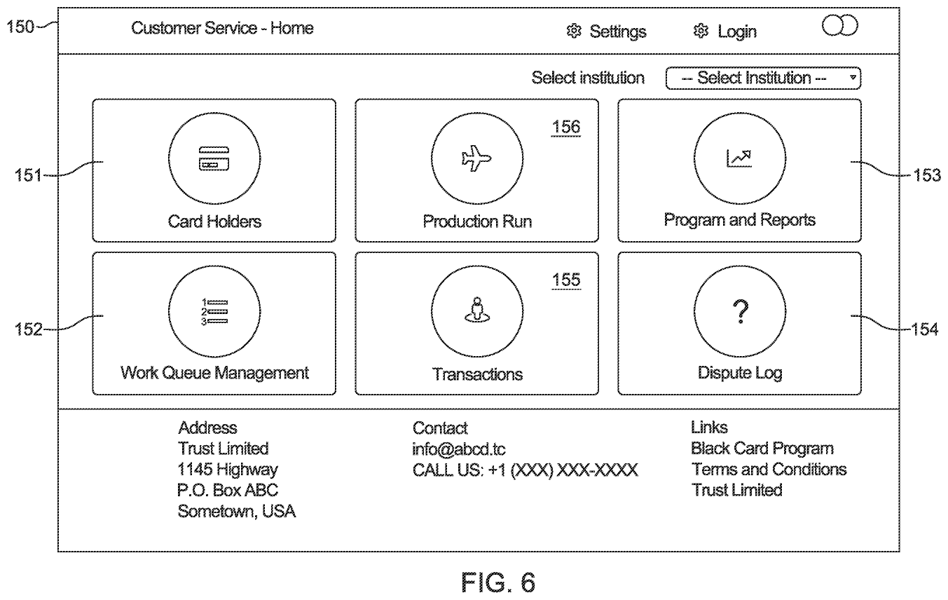

Turning now to FIG. 6, a platform customer services dashboard 150 is generally illustrated. As can be seen, this provides access to a cardholder portal 151, a queue management portal 152, a reports portal 153, a dispute log 154, a transaction portal 155 and a production run portal 156. Other utilities and features provide (but not specifically shown in FIG. 6 include a customer service portal, a mobile transactions dashboard, access to details of voice response systems, and other tools that will be beneficial to users and administrators. As will be recognized, each of these various portals and functions carryout typical and well-known operations, however, provide access from one easy and convenient location.

From a user perspective, eWallet account platform 10 provides for easy enrollment, access and maintenance. Initial registration/account creation is carried out following several simplified and coordinated steps. The collection of initial user information will typically collect user information, including the recording of a picture ID. Naturally initial funding of the account will be determined/collected, including the collection of cash, transfer from related existing accounts (i.e. bank and/or credit card), or perhaps a new account enrollment process (i.e. instant approval debit card). Alternatively a house account may be created. Although typical currency is well recognized, a token or bitcoin/crypto currency-based account could also be contemplated.

As will discussed below, eWallet accounts will have coordinated, easy access tools, including the use of secure login, QR Code reading, multifactor verification, barcode systems, PIN verifications, or other access mechanisms at ATMs, gaming machines, kiosks, POS devices. Ongoing of the account maintenance can be achieved via a user portal. These adjustments can include security settings, transaction history inquiry, account freeze/unfreeze controls, statement look-ups, desired alerts/notification Settings. In addition, the eWallet account platform 10 will also accommodate ACH back to banking accounts.

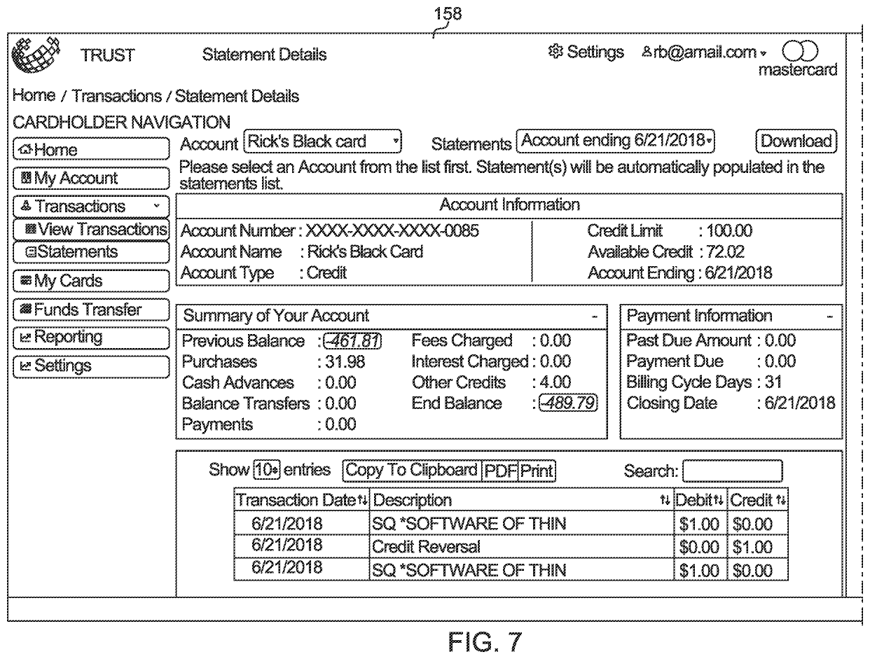

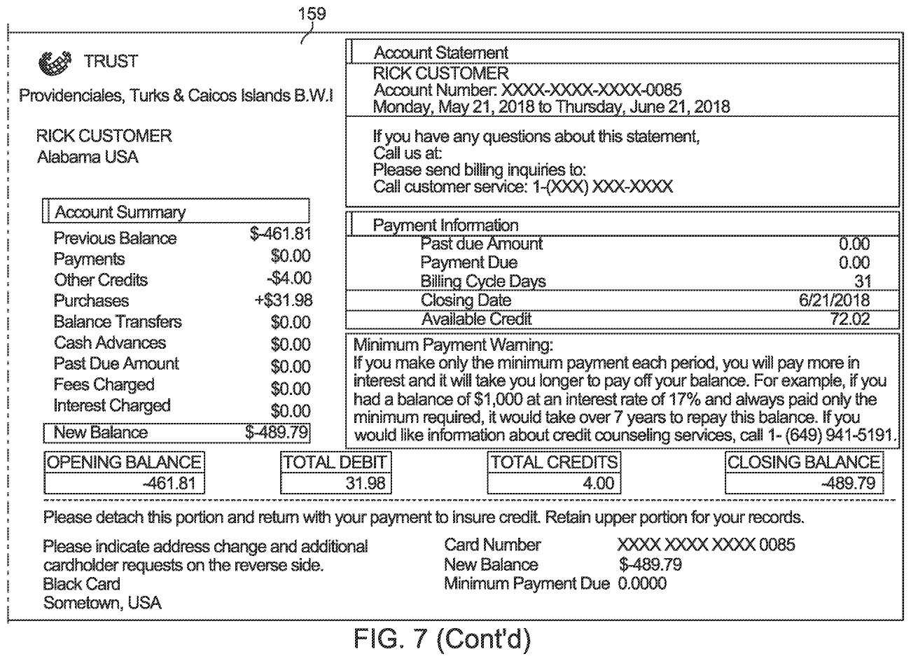

As one example of tools that will be beneficial and easily accessible to users, FIG. 7 presents a user statements dashboard 158, and the ability to view a user statement 159. In the example shown in FIG. 7, the account involved is a credit card account affiliated with the user's eWallet. Dashboard 158 provides the ability to see many details and drill down into details of the user's account. Naturally this will provide significant amounts of detail for the users.

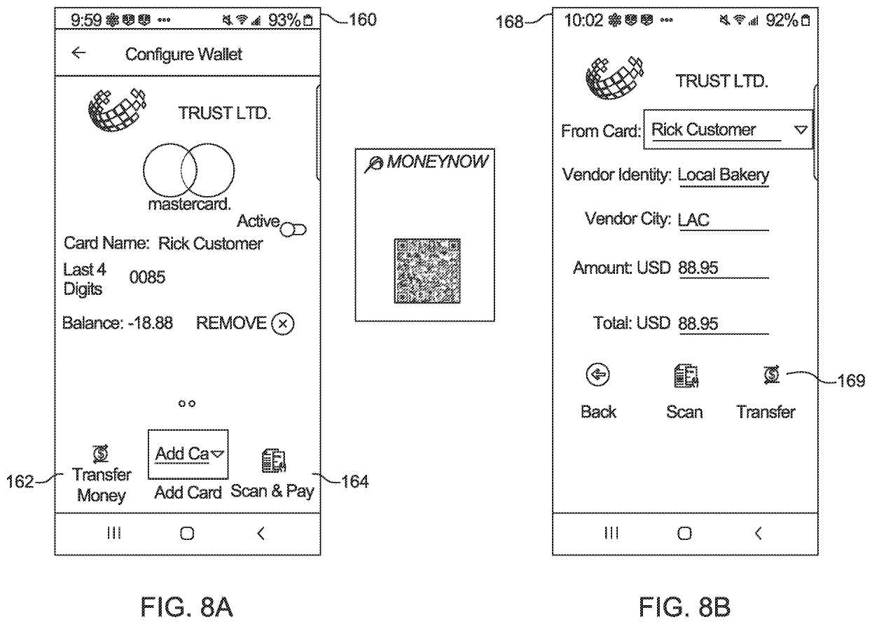

One additional feature provided by eWallet account platform 10 is the ability of users to easily access and make payments at multiple locations. FIGS. 8A and 8B illustrate the payment features made available. As shown in FIG. 8A, and user's card screen 160 is shown, which generally confirms the user's name and provides certain identifying information about a selected card within the user's eWallet. As shown, card screen 160 has a transfer selection option 162 and a scan & pay selection option 164 at the bottom of the screen. By selecting the transfer and pay option 164, and then scanning a merchant's QR code 166, a payment screen 168 is presented, easily allowing the user to make a payment to this merchant. By selecting “transfer”, money will be moved to the merchant using the selected card (or payment option).

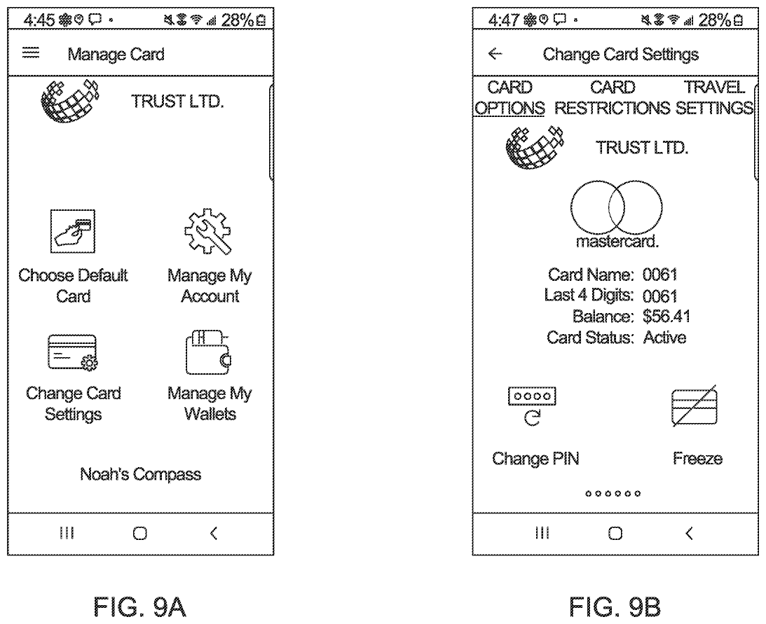

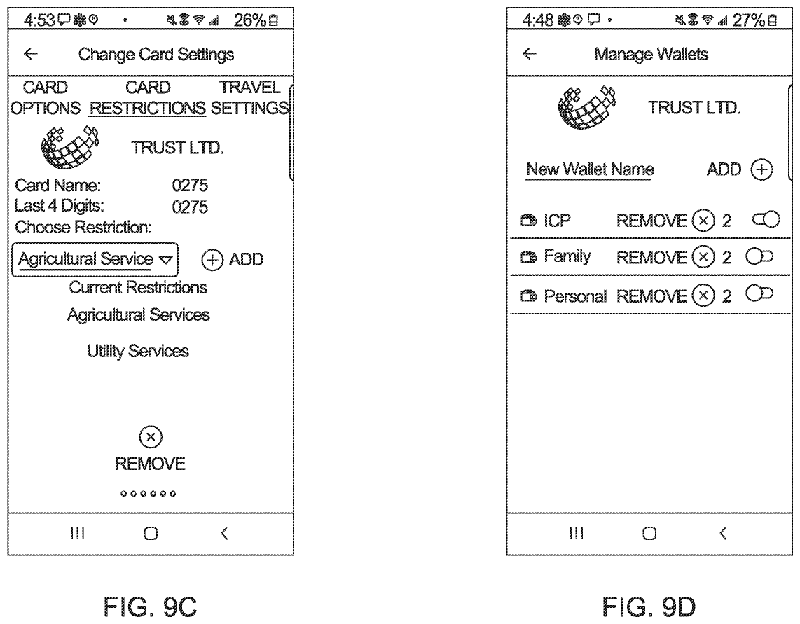

As generally discussed above, the eWallet features and capabilities of processing platform 10 provides additional conveniences and advantages for both users, retail facilities, gaming institutions, financial institutions, administrators, etc. To provide one example, FIGS. 9A-9D illustrate various online screens available to eWallet holders to manage their eWallet accounts. Once logged in, eWallet holders will be presented with a home screen 182 (best shown in FIG. 9A) which provides multiple features and capabilities. This includes the ability to manage settings, choose default cards that will be used in eWallet transactions, change card settings, and manage multiple eWallets. Examples of the subsequent menu screens when any of these options are selected, are illustrated in FIG. 9B (change card options), 9C (establish card restrictions) and FIG. 9D (manage wallets). Naturally, other alternatives and options could potentially be provided to users.

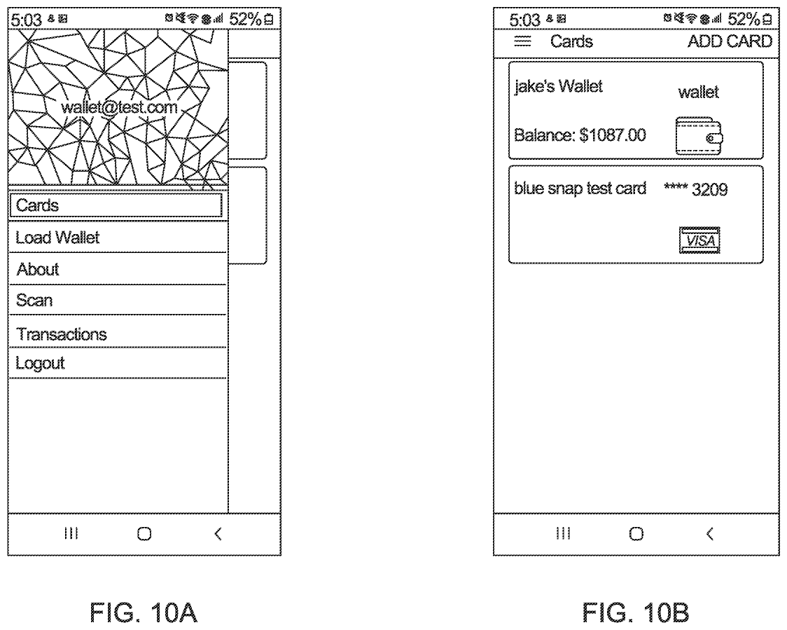

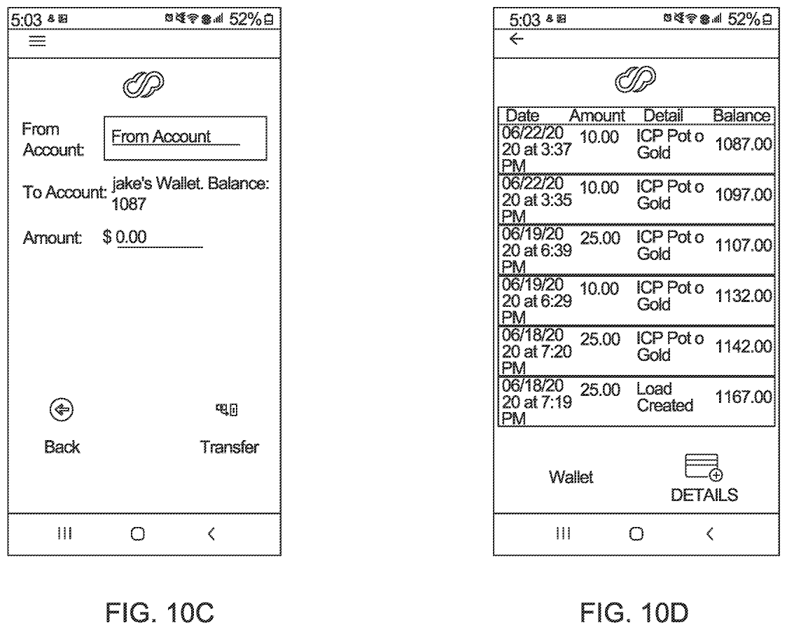

As also suggested above, one particular situation where eWallet account platform 10 is particularly powerful is in the context of certain gaming facilities. In this context, gaming facilities are very broadly interpreted, including establishments that support games of chance, skill based games, bingo based games, lottery based games, etc. More specifically, in the illustrated embodiment eWallet platform 10 allows users to access eWallet accounts from a gaming device or gaming termination interface. Using the multiple resources and connections provided, the user has the ability to fund a wallet (from cash, credit/debit/prepaid cards, ACH transactions, bitcoin accounts, etc.), all while being situated at a gaming terminal. Further, funds can be pushed out to the gaming machine itself for use in game play, or funds can be cashed out to eWallet accounts as necessary. In certain examples, the user is also provided with eWallet administration functions from the gaming terminal itself, including an ability to check balances, view transaction histories and also view nonfictions. Examples of user interface screens presented to a user, while at a gaming institution, are illustrated in FIGS. 10A-10D. More specifically, FIG. 10A illustrates a general homepage for this situation, which is traditionally presented to a user on their mobile device. Similarly, FIG. 10B presents various card options available within the users eWallet, thereby allowing selection as desired. FIG. 10C illustrates a transfer menu, allowing a user to move funds from various accounts within the eWallet. It is also contemplated that a similar screen will allow movement from eWallet accounts to the gaming machine itself. Similarly, FIG. 10D presents a transaction history, thus allowing users to monitor activity and confirm appropriate actions.

Again, it is generally anticipated that access to eWallet functionality at the gaming terminal will be carried out using multiple specific features and functions to provide convenience and security. This will typically include various levels of authentication, using two-factor identification, QR codes, etc. As one example, a QR code may be presented by the gaming terminal itself, thus allowing a user to scan with their mobile device while a backend system confirms authentication. In this manner, security and fraud protection is provided to users and all involved in operation of the eWallet platform.

Again, gaming environments where eWallet can operate include slot machines, lottery, bingo, pull tabs, games of chance, and other casino based games. In the gaming environments, cash-out options include casino located ATMs, the cage and at gaming machines. EWallet platform 10 also supports retail and on-line commerce transactions.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. An eWallet transaction platform for coordinating the management and use of a user's eWallet account within a gaming institution, comprising:
an eWallet platform processor configured to provide financial transaction support to accommodate user eWallet transactions, comprising, withdrawals, transfers, and deposits, the eWallet platform further configured to process ACH transactions, credit card clearing operations, and credit applications processes, the eWallet platform processor further comprising a user wireless communication interface configured to communicate with an eWallet app installed on a user mobile device;
a slot management system having a slot management interface configured to securely interface with the eWallet platform processor, the slot management system further configured to communicate with casino systems comprising an ATM, a plurality of slot machines, and a cashier system, the slot management system further having a gaming institution wireless interface configured to interact with the eWallet app which will enable eWallet transactions involving the ATM, the plurality of slot machines and the cashier system;
wherein eWallet transactions involving the ATM, any one of the plurality of slot machines or the cashier system require a GPS confirmation signal from the user mobile device confirming that the user is located within the gaming institution, and where each eWallet transaction will require a user confirmation signal received from the eWallet app operating on the user mobile device, wherein the GPS confirmation signal and the user confirmation signal are both received via the gaming institution wireless interface.

2. The eWallet transaction platform of claim 1 wherein the slot management system will recognize the presence of the user mobile device withing the gaming institution and will automatically provide signals to the user mobile device to cause operation of the eWallet app to be altered, to thereby better accommodate coordination with the ATM, gaming machine or cashier system.

3. The eWallet transaction platform of claim 2 wherein the user confirmation signal will be generated by the user mobile device scanning a barcode or QR code.

4. The eWallet transaction platform of claim 1 wherein the eWallet platform processor is further configured to receive data from the eWallet app installed on the user mobile device to allow for enrollment in the eWallet, account including electronically receiving information necessary to access an existing account at a user's financial institution.

5. The eWallet transaction platform of claim 4 wherein the eWallet platform processor is further configured to provide a user portal which supports a user interface allowing the user to access status information regarding the eWallet account and to initiate any one of the user eWallet transactions, and a support dashboard configured provide a eWallet platform manager with information regarding a plurality of eWallet account managed by the eWallet platform processor.

6. The eWallet transaction platform of claim 5 wherein the slot management system is configured to provide a gaming institution portal which allows the gaming institution to view eWallet transactions occurring withing the gaming institution.
